(19) United States
(12) Patent Application Publication
(10) Pub. No.: US 2010/0244347 A1
(43) Pub. Date: Sep. 30, 2010

(54) DEVICE AND SYSTEM FOR POSITIONING CIRCULAR WORK PIECES

(75) Inventor: Orazio Maria DAVI, CESENA (IT)

Correspondence Address: YOUNG & THOMPSON, 209 Madison Street, Suite 500, Alexandria, VA, 22314, US

(73) Assignee: PROMAU S.R.L., CESENA (IT)

(21) Appl. No.: 12/581,379

(22) Filed: Oct. 19, 2009

(30) Foreign Application Priority Data
Mar. 31, 2009 (IT) MI2009A000506

(51) Int. Cl. B25B 1/22

(52) U.S. Cl. 269/71

(57) ABSTRACT

A device and a system for positioning work pieces having cylindrical and/or hollow conical bodies, to be processed in workstations. The system comprises at least a first and a second independent positioning devices for positioning and driving in rotation the work pieces to be processed; each positioning device for a base frame provided with two roll groups for supporting the work piece to be processed, each provided with parallely arranged rolls. One or both of roll groups are movable in horizontal and/or vertical direction with respect to the base frame; a gear motor is operatively connected to the roll of at least one of the roll groups for drivingly rotate the work piece to be processed.

### BACKGROUND OF THE INVENTION

This invention refers to a device and a system for positioning circular manufactured work pieces of medium and large diameter ranging for example between 1.5 and 5 mm, to be processed in different workstations, such as hollow shells having a cylindrical and/or conical body suitable for the construction of tanks, tubular elements, wind towers or other work pieces that must be positioned and subjected to different processings, such as welding operations while maintaining the work piece in rotation.

### DESCRIPTION OF THE RELATED ART

For positioning and processing circular work pieces having medium or large dimensions, e.g. for welding cylindrical and/or conical sections in the construction of tubular elements, wind towers or other manufactured work pieces, usually some positioning devices, more simply positioners, are used, of the type having two support points, in which each positioner includes a base frame provided with idle rolls at each end of the manufactured work piece to be processed.

As it is well known, the wind towers for supporting electric generators driven by wind at great heights, comprise a plurality of axially arranged conical or circular sections suitably welded along opposite edges; usually, two large circular sections, each supported by two positioners, are approached and axially aligned until to contact their facing circular edges, having a same diameter, to process them, e.g. for welding.

The two circular sections, in their axially approached condition, are driven to slowly rotate around their longitudinal axis during welding, using large and heavy drive spindles. The positioners substantially are consisting of a simple base frame having a couple of idle rolls to support and slowly rotate the large manufactured circular sections, keeping a working head in a fixed position of a processing line.

This is a very simple system in use since a long time for processing completely metallic carpentry within a suitably equipped factory or steady workstations.

A limitation of these large installations relates to rotation of large spindles provided with a very bulky motor drive, involving the use of stationary workstations in plants having a limited working flexibility under operation point of view. Further this causes the users to assemble the manufactured work pieces always in a same work area; in fact it is very difficult and anti-economical to move the positioners to another work area within a same factory, or directly in a building yard, as this could require the displacement of a whole work line. Positioning and perfect alignment of the circular sections is made difficult involving the use of conventional systems such as wedges, cranes and chains.

The problem is made more complex when the work pieces to be processed have a conical shape, such e.g. in the construction of wind towers; in these cases the ends of two large conical sections to be welded must be precisely approached with one another, as their conical shape compels the operator to tilt slightly them in relation to their conical angle, for keeping their longitudinal rotational axis in horizontal position.

Then the presently existing positioners cannot be easily adjusted for circular work pieces having different diameters; further the tilting of the same manufactured work piece cannot be changed for aligning their opposite ends, perfectly in contact, in particular to coaxially drive them during a processing step.

Further, in the case of conical sections for wind towers, use is made of metal sheets having a thickness comparatively thinner with respect to a mean diameter of the work piece; then they prove to have a suitably flexible and elastic structure that causes their deformation when laid on positioner rolls.

Also eventual circularity errors in the diameter, or ovalization of the manufactured work piece constitutes a disadvantage to be removed when a quick, efficient and automated welding or processing operations are requested, as the approached circular ends of conical sections, if they are not perfectly identical, would involve height differences that must be corrected, especially in manufactured work pieces having large dimensions, and diameters in the range of 2 or 3 meters, or higher, showing a difficult handling when actual positioners are used.

### OBJECTS OF THE INVENTION

A first object of this invention is to provide a positioning device for circular manufactured work pieces or bodies having large dimensions, and a related positioning system including two or more functionally co-related positioning devices, for handling and a correct adjustment of relative positions among circular manufactured work pieces, keeping their longitudinal axes perfectly aligned, independently from the their cylindrical and/or conical shape.

A further object of the invention is to provide a device and system for positioning circular manufactured work pieces having cylindrical and/or hollow conical bodies to be processed, as previously set for, in which each positioner comprises an autonomous drive system for causing the rotation of manufactured work piece, and in which each positioner can be easily transferred, that is moved in different workstations within a same factory, or in building yards.

A further object of this invention is to provide a device and system for positioning circular manufactured work pieces having large diameters, by which it is possible to use a diameter defect correction device for correcting circularity defects, obtaining consequently an easier coupling, and a more precise and quick welding or processing operations.

### SUMMARY OF THE INVENTION

According to a first embodiment of the invention, a positioning device has been provided for positioning and driving in rotation a work piece of medium or large dimension to be worked having a circular shape, the positioning device comprising:

a longitudinally extending base frame;

first and second spaced apart roll groups on the base frame, each roll group provided with a support roll for the work piece having a rotational axis, at least one of said roll groups being movably supported in the longitudinal direction of the base frame at a right-direction to the rotation axis of roll;

a drive unit operatively connected to the roll of at least one of the roll groups, to drive in rotation the work piece to be processed; and

control means conformed to horizontally and/or vertically move the roll groups in respect to the base frame.

According to another embodiment of the invention, a positioning system for supporting, processing and driving in rotation at least a first and a second circular work pieces in axially aligned condition, the positioning system comprising:

a plurality of positioning devices, in which each positioning device comprises first and second roll groups each provided with a support roll; and control means for horizontally and/or vertically moving at least one of said roll groups;

a drive unit for rotation of the support roll of at least one of the roll groups of each positioning device; and

an electronic control unit operatively connected to said control means and to the drive units of the positioning devices, said electronic control unit being conformed and programmable for adjusting the horizontal and/or vertical position of the roll groups, respectively the rotation speed of the driven support rolls.

### BRIEF DESCRIPTION OF THE DRAWINGS

These and further characteristics and advantages of the positioning device and system for driving in rotation medium and large circular work pieces, according to the invention, shall appear more clearly from the following description and drawings related to some exemplary embodiments, in which:

FIG. 1 is a top view of a positioning device according to the invention;

FIG. 2 is a lateral view of FIG. 1;

FIG. 3 is a cross-sectional view, according to line 3-3 in FIG. 1;

FIG. 4 shows the use of two positioning devices for supporting a cylindrical work piece;

FIGS. 5 and 6 are illustrative schemes showing the swing and self-orientation of the support rolls to conform them to the conical or cylindrical shape of a circular work piece;

FIG. 7 is a schematic drawing showing the use of four positioning devices for supporting and positioning two conical work pieces be welded, for the construction of a wind tower;

FIG. 8 is a schematic drawing of a supplementary device for correction of circularity defects, forming part of a positioning system according to the present invention;

FIG. 9 is a schematic drawing, in block diagram, of the positioning and control system according to the invention.

### DESCRIPTION OF THE PREFERRED EMBODIMENTS

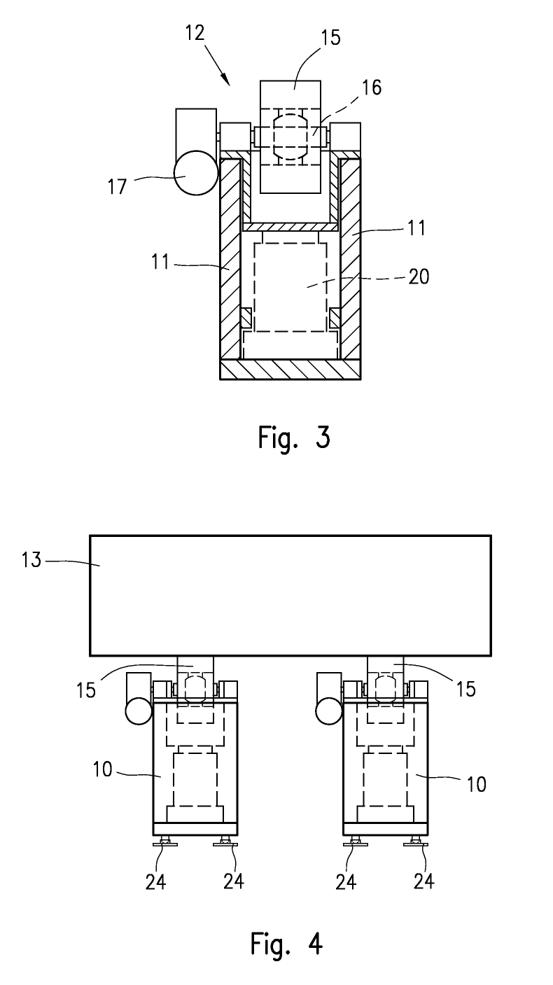

FIGS. 1 to 3 schematically show the general characteristics of a positioning device for supporting and driving in rotation work pieces having hollow bodies of circular shape, e.g. cylindrical hollow sections for the construction of tanks, tubular work pieces, or wind towers, the positioning device forming a part of a positioning system according to the present invention.

As shown, the positioning device 10 comprises a base frame laid on ground, having lateral walls 11 that parallely extend with one another in a longitudinal direction of the base frame.

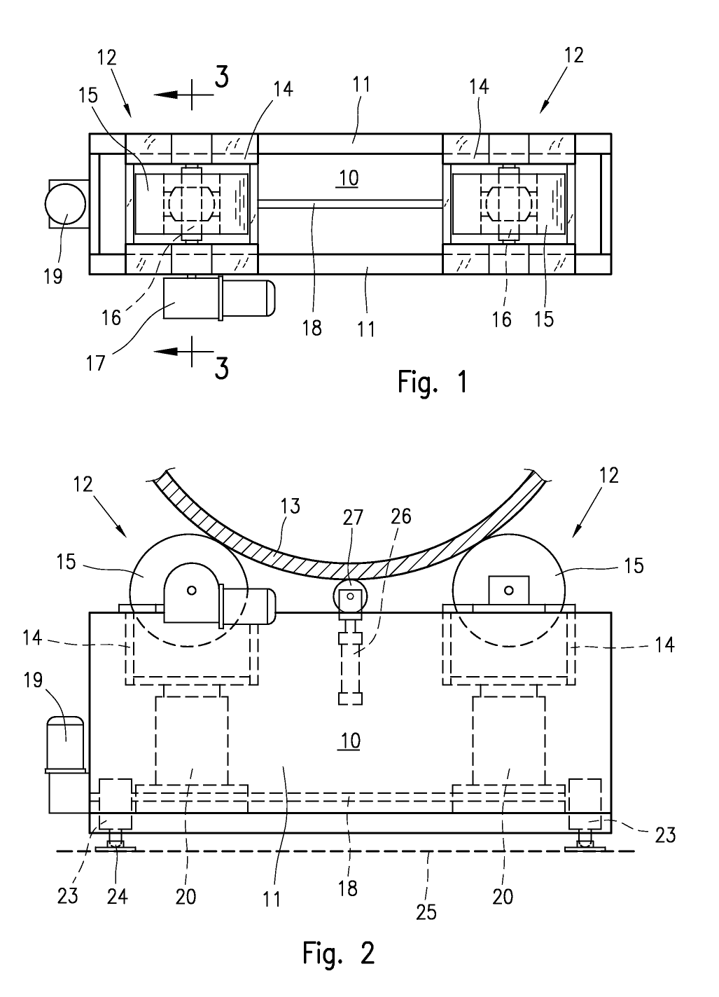

The positioning device 10 further comprises spaced apart first and second roll groups 12, each adjustable both in vertical and horizontal direction along the longitudinal axis of the base frame 10, for positioning and driving in rotation a circular work piece having a hollow body 13, partially shown in FIG. 2.

Each roll group 12 includes a slider 14 provided with a support roll 15 for the work piece 13 to be positioned and driven in rotation.

Each support roll 15 is mounted on the slider for rotation around a horizontal axis 16, one of the roll being idler while the other one of the support rolls being driven by a gear motor 17.

The space between the axes 16 of two parallely arranged rolls 15 can be adjusted and changed in relation to the diameter at which both rolls 15 come in contact with the hollow body 13 of the work piece to be supported; this can be made in any suitable manner, e.g. by moving one or both the two roll groups 12 on the base frame. To this purpose, according to the present example, the slider 14 of each roll group is slidably supported along guide surfaces of the base frame, e.g. along the upper edges 11′ of the lateral walls 11, as shown; a double screw control device, having left and right handed threads, schematically shown by reference number 18, driven by a motor 19, such as a hydraulic or pneumatic actuator or other suitable drive device, allows to approach and move away the sliders 14 in a controlled manner, adjusting in this manner the space between the rolls 15.

Each roll group 12, in addition to be horizontally movable along the base frame, in a first direction at a right-angle in relation to the roll axis 16, can be vertically moved in a second direction at a right-angle to the rotational axis 16 for adjusting the position in height of the same support roll 15, according to variable exigencies or needs of the positioning device 10.

The adjustment in height of each roll group 12 can be made again in any way and by any suitable means; e.g., in the case shown, the adjustment in height can be made by a hydraulic cylinder 20 or by other lifting means. To this purpose it is advisable to provide each roll group 12 with second vertical guide means.

According to another feature of the positioning device 10, the base frame can be tilted laterally with respect to a horizontal reference plane, e.g. the ground on which the same base frame lays on, lifting the roll group laterally at one or both ends. Again this can be made by using any suitable lifting means; as a solely indicative aim, FIGS. 2 and 4 show schematically the use of hydraulic cylinders 23 at each end of the base frame provided with swiveling feet 24 leaning on the ground 25.

FIG. 2 shows further the use of an auxiliary device 26 for lifting the hollow body of the work piece 13, in an intermediate position between the rolls 15 of two roll groups 12; again the lifting device 26 can be differently made, e.g. by a hydraulic cylinder whose rod has a contact roll 27 to contact the circular outer surface of the work piece 13.

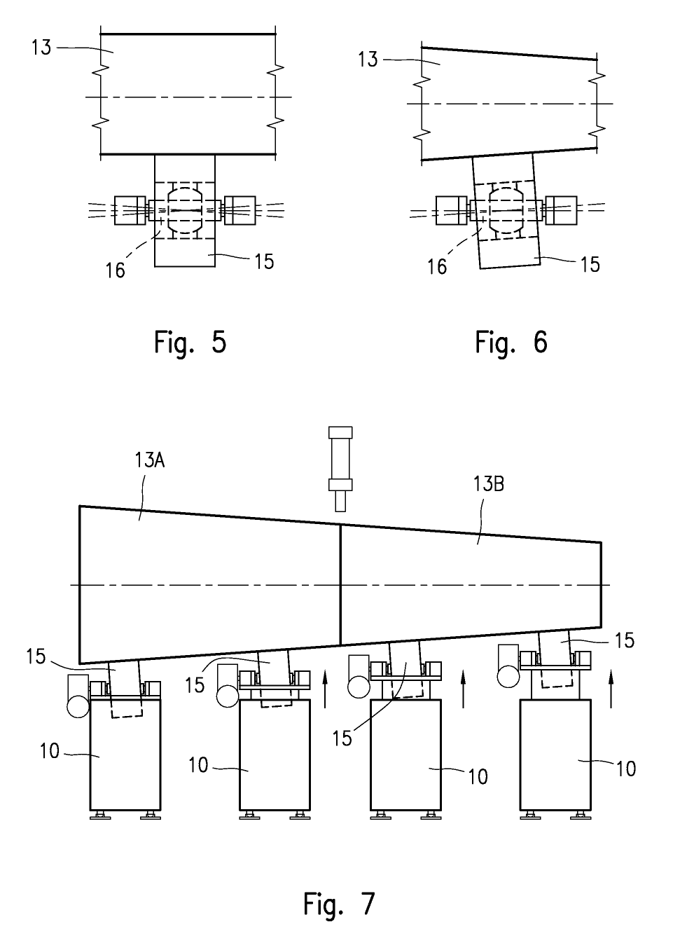

Both in relation to the exigency of positioning manufactured work pieces conformed by hollow bodies 13 having a cylindrical or conical shape, and in relation to the possibility to tilt the base frame, it is advisable that the support rolls 15 be provided with a freely and self-orienting tilting system conforming to the cylindrical or conical shape of the work piece 13; this is schematically shown, as an example in FIGS. 5 and 6, with the possibility to support the work piece 13 keeping its longitudinal rotational axis in a horizontal position.

As stated above, the support rolls 15 for the work piece 13 can rock around an axis at a right-angle with respect to their rotational axis; these arrangements, in combination with the raising of the roll groups 12, allow to control the positioning of the work pieces 13 in axially aligned positions, as shown by 13A and 13B in FIG. 7, lifting and/or lowering them at one or both ends, or titling with the aim of perfectly coupling, causing the juxtaposition of the opposite ends to be welded or processed.

Each positioning device 10 is completely independent with respect to the other devices 10 which are part of a same positioning system; therefore each positioning device 10 of a system may be easily moved in any working position to establish the work area according to the decision of an operator. They can be also installed in a building yard for allowing a welding and/or other processing operations directly in the use place, with the following advantage of allowing the transport of single work pieces having cylindrical or conical bodies, separately, and successively welding and processing them in the building yard.

The FIG. 7 schematically shows, as an indicative example, the use of four devices 10 for positioning two conical work pieces or sectors 13A and 13B for manufacturing a wind tower, that must be welded after having mated perfectly their opposite ends. As circular bodies having large dimensions, owing to sheet elasticity or owing to the same roll bending operation to which they have been previously submitted, can have circularity defects, or a certain ovalization degree, it is possible to provide the positioning devices 10 supporting the two opposite ends of the conical sectors 13A and 13B, with suitable circularity correction means; as alternative it can be provided the use of an intermediate correction device on a separate positioner between the faced ends of the circular sectors to be welded.

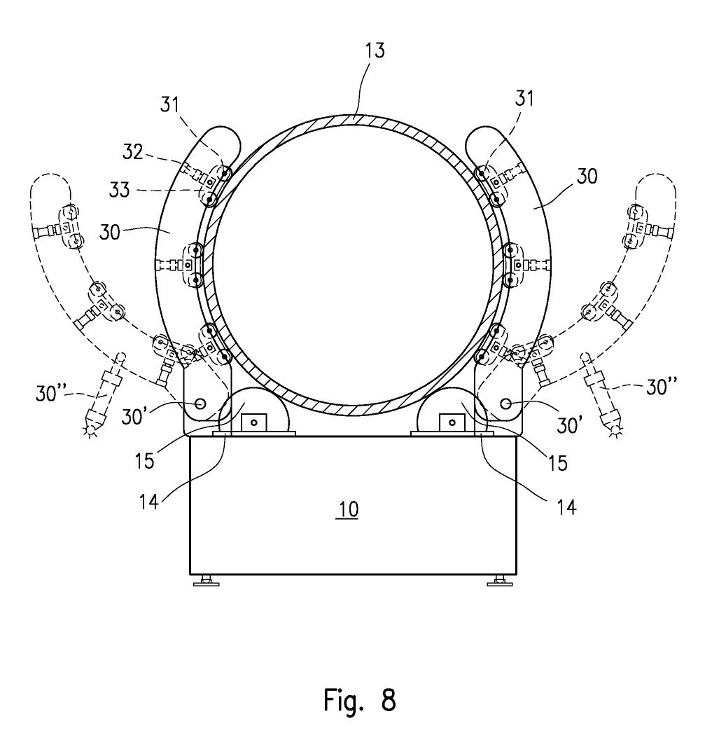

FIG. 8 shows, as illustrative purpose, in a purely schematic manner, a positioner 10 having a circularity correction device for the work pieces 13. The positioner 10 is substantially similar to the one previously described; therefore there the same reference numbers have been used for similar or equivalent parts.

The circularity correction device, in the shown example, comprises a support structure for a plurality of thrust rolls, e.g. comprising two or more arch shaped self-centering arms 30, hinged at 30′ to the base frame 10; each arm 30 comprises a plurality of angularly spaced apart thrust rolls 31, to contact the outer surface of a work piece or of two aligned work pieces 13 on a prefixed diameter. The thrust rolls 31 are supported in a radially adjustable manner, e.g. by hydraulic cylinders 32, or linear actuators of any type, to be moved to and from the work piece or tower section 13. The arms 30 may be moved by an actuator such as a hydraulic cylinder 30″.

As an alternative, the thrust rolls 31 can be supported in a freely pivotable manner, e.g. by a frame 33 hinged to the rod of a hydraulic cylinder 32, as schematically shown in FIG. 8; further these thrust rolls 31 can be self-aligning along their longitudinal rotational axis, in the manner previously described, for being oriented in conformity with the conical or cylindrical surface of work piece or tower section 13.

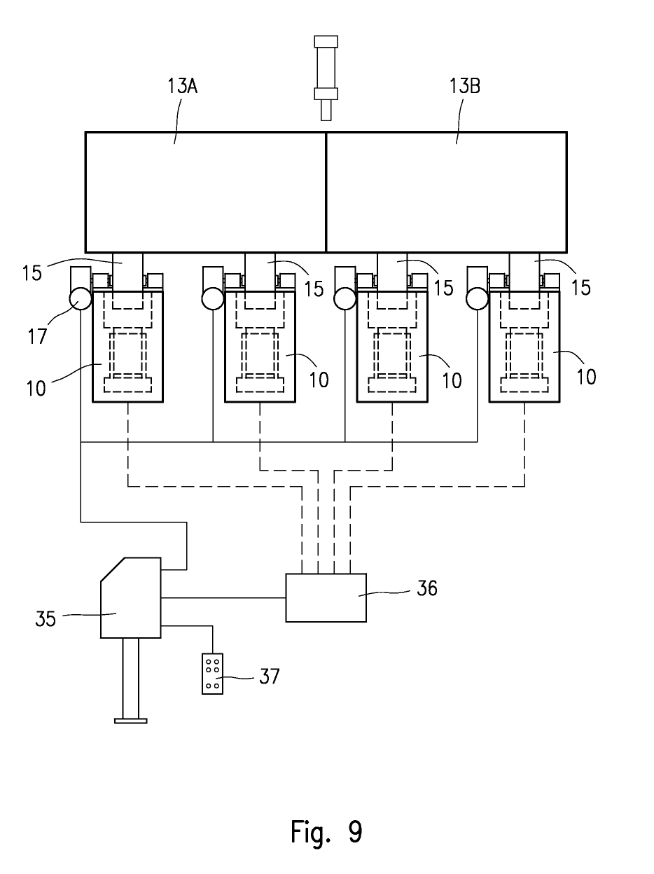

The FIG. 9 shows, always as an exemplificative purpose, a positioning system for the welding of two cylindrical bodies of work pieces 13A, 13B, in which the positioning devices are shown schematically.

As shown in the FIG. 9, each cylindrical body 13A, 13B is supported by two positioning devices 10, whose support rolls 15 have been adjusted in height and in longitudinal direction to the base frame, as previously described.

Always in FIG. 9, reference 35 shows an electronic control unit for controlling the geared motors 17 for driving the support rolls 15 and for rotation of the cylindrical bodies of the work pieces 13A, 13B; further the hydraulic and/or pneumatic actuators 20, 23, 32 of the positioners 10 are operatively connected to a hydraulic and/or pneumatic power source 36 for supplying a pressurized fluid. Lastly, reference number 37 relates to a wireless remote control that advantageously can be used by an operator, inside the cylindrical or conical bodies of work pieces, for controlling alignment of the cylindrical bodies by lifting and/or lowering the roll groups 12, in this manner rendering completely autonomous the whole positioning system.

There are multiple advantages that can be got both by the positioning devices and the positioning system according to the present invention, in particular:

allow the handling of medium and large cylindrical or conical bodies, in autonomous manner;

large cylindrical or conical bodies, can be correctly positioned by adjusting them in height and/or slope;

two cylindrical or conical bodies can be correctly positioned, aligning their opposite ends, lifting and/or lowering one with respect to the other until it is got the coincidence of their circumferential edges;

the longitudinal axis of both cylindrical and conical bodies can be kept in a perfectly horizontal condition, allowing both bodies to be maintained in an axially aligned condition during rotation;

welding and/or other mechanical operations may be performed on the contacting ends of the bodies of the work pieces, in a completely automatic manner, these operations being made with great difficulties by using conventional positioning systems;

further allow the possibility to correct circularity or ovalization defects, and to make the work more precise and easy, by operations more rapid and precise; in this manner it is completely avoided the use of traditional hoisting devices, such as chains bridge cranes, hoisting trolleys and other;

a control autonomy of the rotational or speed, is also possible for conical or cylindrical bodies, by applying each time a required rotational speed in relation to processing operation.

Owing to above and shown in annexed drawings, it will be understood that, according to this invention, a positioning and rotational driving device and system have been provided for medium and large metal sheet circular work pieces, e.g. for cylindrical and/or conical bodies for the construction of tubular elements, pressure tanks, wind towers and the like, by which said advantages are obtained. Therefore other modifications or variants can be made both in the positioning devices, and in the whole system, or its parts, without departing from the claims.

What we claim is:

1. A positioning device for positioning and driving in rotation a work piece of medium or large dimension to be worked, having a circular shape, characterized by comprising:
a longitudinally extending base frame;
first and second spaced apart roll groups on the base frame, each roll group provided with a support roll for the work piece, having a rotational axis, at least one of said roll groups being movably supported in the longitudinal direction of the base frame, at a right-direction to the rotation axis of roll;
a drive unit operatively connected to the roll of at least one of the roll groups, to drive in rotation the work piece to be processed; and
control means conformed to horizontally and/or vertically move the roll groups in respect to the base frame.

2. A positioning device according to claim 1, comprising control means for adjusting the height of each roll group.

3. A positioning device according to claim 1, wherein the support rolls are angularly adjustable along an axis at a right-direction to their own rotational axis.

4. A positioning device according to claim 1, comprising means for raising and/or tilting the base frame.

5. A positioning device according to claim 1, comprising an additional lifting device for raising the work piece to be processed.

6. A positioning device according to claim 1, comprising a defect correction device for correction of circularity defects of a work piece, the correction device comprising a support structure provided with a plurality of pressure rolls, said pressure rolls being arranged to at least partially surround and come in contact with the work piece; and control means for adjusting the contact force between the pressure rolls and the work piece.

7. A positioning device according to claim 6, wherein the pressure rolls are connected to the support structure in an angularly adjustable manner, at a right-direction to its own rotation axis.

8. A system for positioning and driving in rotation circular work pieces, according to which at least two work pieces having hollow bodies are supported in an aligned condition and are driven to rotate during processing, the system comprising:
a plurality of positioning devices, in which each positioning device comprises first and second roll groups each provided with a support roll; and control means for horizontally and/or vertically moving at least one of said roll groups;
a drive unit for rotation of the support roll of at least one of the roll groups of each positioning device; and
an electronic control unit operatively connected to said control means and to the drive units of the positioning devices, said electronic control unit being conformed and programmable for adjusting the horizontal and/or vertical position of the roll groups, respectively the rotation speed of the driven support rolls.

9. A positioning system according to claim 8, in which each positioning device comprises hydraulic and/or pneumatic actuators operatively connectable to a pressurized fluid source, said electronic control unit being programmable to connect said hydraulic or pneumatic actuators selectively to the pressurized fluid source.

10. A system according to claim 8, in which the electronic control unit comprises a wireless remote control.
